(19) United States
(12) Patent Application Publication
(10) Pub. No.: US 2013/0059458 A1
(43) Pub. Date: Mar. 7, 2013

(54) CARD EDGE CONNECTOR

(71) Applicant: Wen Chang Chang, Keelung City (TW)

(72) Inventor: Wen Chang Chang, Keelung City (TW)

(73) Assignee: LOTES CO., LTD., Keelung (TW)

(21) Appl. No.: 13/325,813

(22) Filed: Dec. 14, 2011

(30) Foreign Application Priority Data
Sep. 1, 2011 (CN) 201120331326.4

(51) Int. Cl. H01R 13/62

(52) U.S. Cl. 439/328

(57) ABSTRACT

A card edge connector for receiving an electronic card to be inserted therein includes an insulating body, with a slot formed therein for receiving the electronic card therein; multiple conductive terminals, accommodated in the insulating body, in which each of the conductive terminals at least partially enters the slot and contacts the electronic card therein; and at least one latch. The latch includes a connecting arm with one end disposed in the insulating body and located at a side of the slot; a bent section, extending backward from the other end of the connecting arm and bent toward a side away from the electronic card; and a guide chamfer, disposed at a side of the bent section close to the electronic card and inclined downward.

### CROSS-REFERENCE TO RELATED APPLICATION

This non-provisional application claims priority under 35 U.S.C. §119(a) on Patent Application No. 201120331326.4 filed in P.R. China on Sep. 1, 2011, the entire contents of which are hereby incorporated by reference.

Some references, if any, which may include patents, patent applications and various publications, are cited in a reference list and discussed in the description of this invention. The citation and/or discussion of such references is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a card edge connector, and more particularly to a card edge connector with a latch that is not easily damaged.

### BACKGROUND OF THE INVENTION

A card edge connector is disposed on a circuit board and capable of receiving an electronic card to be inserted therein, so as to implement electrical connection between the circuit board and the electronic card. For example, a card edge connector for receiving a memory stick in a notebook computer is usually of a horizontal type, which includes an insulating body fixed on a main board. A slot is formed on the insulating body. Multiple conductive terminals disposable in the insulating body correspondingly enter the slot and are electrically connected to an electronic card received in the slot. Two opposite tail ends of the slot are respectively disposed with a metal latch. The metal latch includes a connecting arm extending along a straight line from the tail end of the slot, and a buckling portion extending from a tail end of the connecting arm toward a side where the electronic card is located. The buckling portion has an inclined guide surface formed through bending downward from a top surface of the tail end of the connecting arm, which may guide the electronic card to be rotated, pressed, and buckled to a working position.

When the electronic card is inserted, a front end of the electronic card is obliquely inserted into the slot first, so that a connecting finger (gold finger) at the front end of the electronic card contacts the conductive terminal. Then, a rear end of the electronic card is pressed downward with the front end as an axis of rotation, so that the rear end of the electronic card rotates downward. When the rear end of the electronic card rotates, an edge of the electronic card extrudes the inclined guide surface and applies a lateral acting force on the inclined guide surface, which makes the buckling portion expand outward. At this time, the buckling portion moves toward the outside to leave a space, and driven by the buckling portion, the connecting arm undergoes an elastic deformation, so as to accumulate elastic potential energy. The rear end of the electronic card is pressed downward to a working position along the inclined guide surface. Finally, the buckling portion restores to its initial position under an elastic restoring force of the connecting arm, and buckles on an upper surface of the electronic card.

In such a card edge connector, since the connecting arm extends along a straight line from the tail end of the slot, and the inclined guide surface is formed through bending downward from the top surface of the tail end of the connecting arm, the top surface of the connecting arm is higher than the inclined guide surface, and therefore the card edge connector has the following defects.

1. When the electronic card is in an abnormal insertion state, that is, when the front end of the electronic card does not completely enter the slot, the connecting finger part is askew to some extent. At this time, the rear end of the electronic card shifts from the normal position significantly. The edge of the electronic card is deviated from the inclined guide surface, and therefore directly press the top surface of the connecting arm. When a user presses the electronic card downward forcibly, as the top surface of the connecting arm only has a vertical acting force on the edge of the electronic card, the top surface of the connecting arm fails to expand outward to leave a space for the electronic card. As a result, the electronic card cannot be pressed downward to the normal working position.

2. Furthermore, the latch is easily damaged due to an excessive force applied by the user, thereby losing the original function of buckling the electronic card.

3. The latch is fixedly disposed in the insulating body, and the insulating body is usually fixedly disposed on the main board. When the latch is damaged, the entire card edge connector and the main board need to be replaced, which increases the cost for a user/owner/operator.

Therefore, a heretofore unaddressed need exists in the art to address the aforementioned deficiencies and inadequacies.

### SUMMARY OF THE INVENTION

In one aspect, the present invention is directed to a card edge connector with a latch that is not easily damaged.

In one embodiment according to the present invention, a card edge connector for receiving an electronic card to be inserted therein includes: an insulating body, with a slot formed therein for receiving the electronic card therein; multiple conductive terminals, accommodated in the insulating body, in which each of the conductive terminals at least partially enters the slot and contacts the electronic card therein; and at least one latch. The latch includes: a connecting arm, in which an end of the connecting arm is disposed in the insulating body and is located at a side of the slot; a bent section, extending backward from the other end of the connecting arm and bent toward a side away from the electronic card; and a guide chamfer, disposed at a side of the bent section close to the electronic card and inclined downward.

In another embodiment, the bent section includes a bent segment bent from a tail end of the connecting arm toward a side away from the electronic card, and a straight segment extending backward from a tail end of the bent segment and parallel to the connecting arm.

The guide chamfer extends integrally from the bent section.

The bent section and the guide chamfer are connected through a transition plane.

A pulling portion is disposed at a rear end of the bent section, and the pulling portion is formed through gradual widening of the guide chamfer from front to back.

The latch further includes an extending arm located at a side of the connecting arm and away from the side where the electronic card is located, and the guide chamfer is formed through extending from the extending arm.

A notch is formed at a side edge of the electronic card, a stopping portion is disposed on the latch, and the stopping portion extends toward the side where the electronic card is located and enters the notch, so as to prevent the electronic card from moving forward and backward.

The stopping portion is formed through extending from the bent section.

The bent section is located in front of the stopping portion.

The card edge connector is of a sinking type.

Compared with the related art, a card edge connector of the present invention adopted with the above technical solution, among other things, has the following advantages. In the card edge connector, the connecting arm extends backward and is bent to form the bent section away from the electronic card, so that a certain distance is maintained between the top surface of the bent section and the edge of the electronic card (at the normal working position). When the front end of the electronic card does not completely enter the slot, making the connecting finger part askew to some extent, even if the rear end of the electronic card substantially aligned with the bent section shifts from the normal position laterally, the edge of the electronic card does not press the top surface of the bent section since the bent section is away from the edge of the electronic card, but instead, contacts the guide chamfer and applies a lateral acting force thereon, so that the guide chamfer expands outward to leave a space for the electronic card, therefore preventing the latch from being damaged due to an excessive pressure, effectively ensuring the function of the latch for buckling the electronic card, and saving the cost.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is an exploded view of a card edge connector according to one embodiment of the present invention;

FIG. 2 is a three-dimensional schematic view of a front end of an electronic card normally inserted into a card edge connector according to the embodiment of the present invention and not pressed downward;

FIG. 3 is a schematic view of a front end of an electronic card normally inserted into a card edge connector according to the embodiment of the present invention and not pressed downward;

FIG. 4 is a schematic view of a front end of an electronic card normally inserted into a card edge connector according to the embodiment of the present invention and pressed downward; and

FIG. 5 is a schematic view of a front end of an electronic card abnormally inserted into a card edge connector according to the embodiment of the present invention and not pressed downward.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

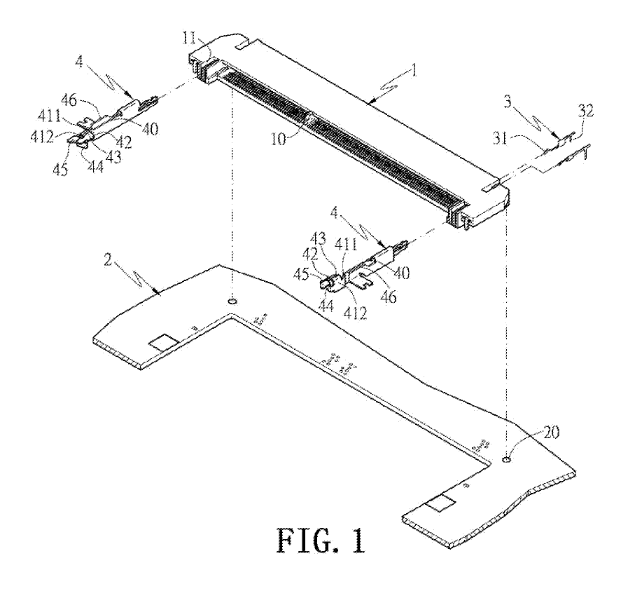

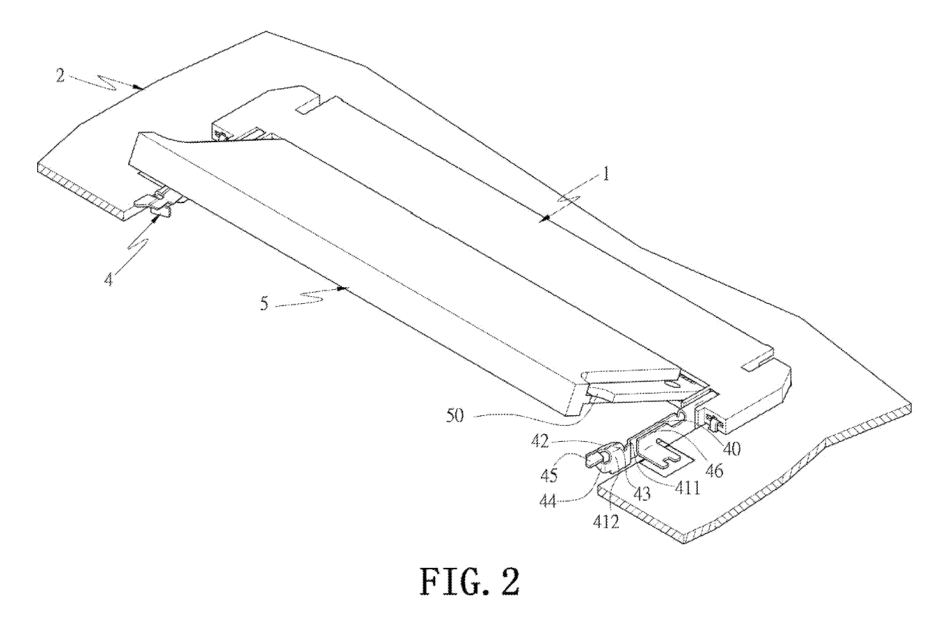

Referring to FIG. 1 and FIG. 2, a card edge connector according to one embodiment of the present invention is of a sinking type and includes: an insulating body 1 disposed on a circuit board 2, in which a slot 10 is formed on the insulating body 1; multiple conductive terminals 3 arranged in the insulating body 1; and two latches 4 disposed in the insulating body 1 and respectively located at two opposite sides of the slot 10 for buckling an electronic card 5.

Referring to FIG. 1 and FIG. 2, two ends of the insulating body 1 respectively extend downward to form a positioning post (not shown). Two positioning holes 20 corresponding to the two positioning posts are formed on the circuit board 2, in which the two positioning posts (not shown) are respectively inserted in the two positioning holes 20. The slot 10 for receiving the electronic card 5 is formed from back to front on the insulating body 1. Two accommodating grooves 11 are formed at two opposite ends of the slot 10 from back to front on the insulating body 1.

The multiple conductive terminals 3 are arranged in an upper row and a lower row in the insulating body 1. Each of the conductive terminals 3 has a contact portion 31 entering the slot 10 and contacting the electronic card 5, and a soldering portion 32 exposed below the insulating body 1, in which the soldering portion 32 may be soldered to the circuit board 2 at a position higher than a lower surface of the insulating body 1.

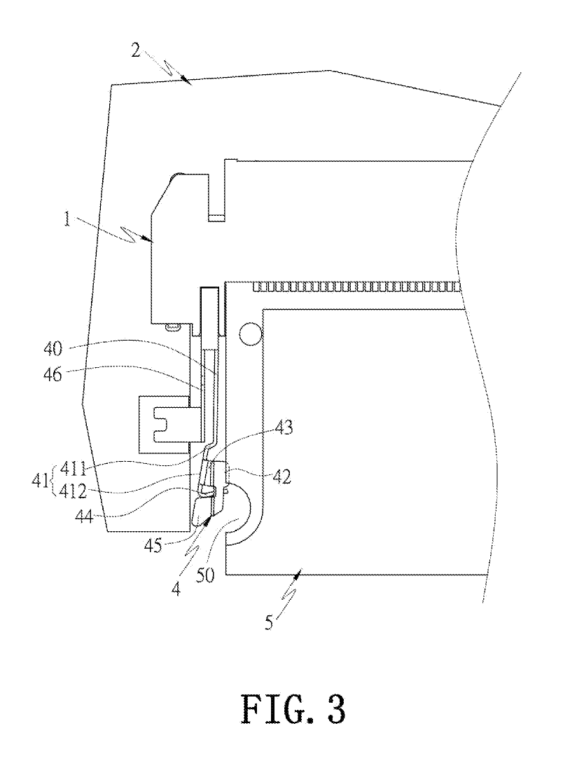

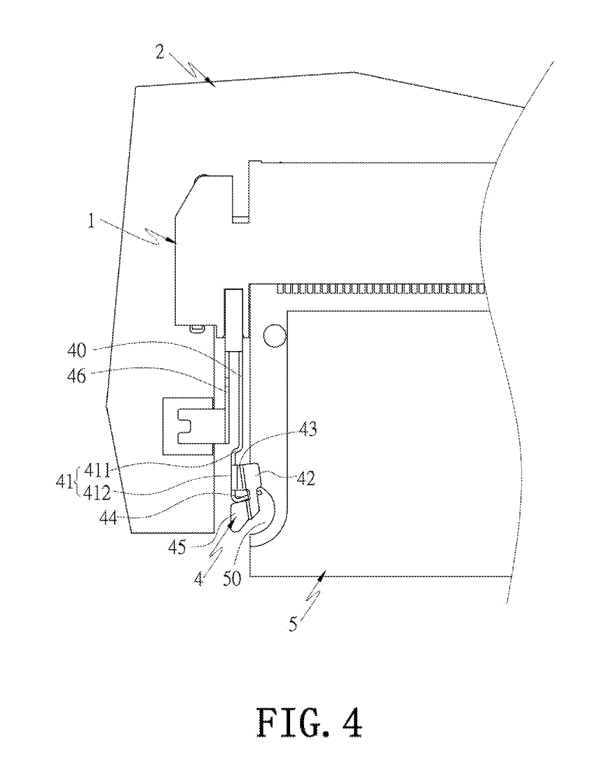

Referring to FIG. 1, FIG. 3 and FIG. 4, the two latches 4 are made of a metal material, and are respectively disposed at two opposite ends of the slot 10. A bottom surface of the latch 4 is lower than an upper surface of the circuit board 2. The latch 4 includes a connecting arm 40, a bent section 41 that is formed through extending backward from the connecting arm 40 and bending, and a guide chamfer 42 formed through extending from the bent section 41.

A front end of the connecting arm 40 is inserted in the accommodating groove 11 of the insulating body 1, and extends backward along a straight line from the accommodating groove 11.

The bent section 41 includes a bent segment 411 bent from a tail end of the connecting arm 40 toward a side away from the electronic card 5, and a straight segment 412 extending backward from a tail end of the bent segment 411 and parallel to the connecting arm 40.

The guide chamfer 42 and the bent segment 41 are integrally formed, and specifically are formed through bending and extending a top surface of the straight segment 412 toward the side where the electronic card 5 is located. Limited by the stamping technology, during a process of bending downward the top surface of the tail end of the connecting arm 40 to form the guide chamfer 42, a transition plane 43 inevitably exists in a connection part between the tail end of the connecting arm 40 and the guide chamfer 42. The transition plane 43 is substantially aligned with the top surface of the connecting arm 40, and is higher than the guide chamfer 42. The guide chamfer 42 extends downward obliquely from the transition plane 43 toward a side of the electronic card 5.

A stopping portion 44 is disposed on the latch 4, extends toward the side where the electronic card 5 is located, and enters a notch 50 on a side edge of the electronic card 5, so as to prevent the electronic card 5 from moving forward and backward. The stopping portion 44 is formed through extending backward from a tail end of the straight segment 412 toward the side where the electronic card 5 is located, is located below the guide chamfer 42 and is correspondingly aligned with the notch 50.

A pulling portion 45 is disposed at a rear end of the bent section 41, and the pulling portion 45 is formed through gradual widening of the guide chamfer 42 from front to back.

The latch 4 further includes an extending arm 46 formed through extending laterally from a portion close to the front end of the connecting arm 40 and extending backward, and the extending arm 46 is away from the side where the electronic card 5 is located and used to be fixed to the circuit board 2 by soldering. The extending arm 46 is substantially parallel to the connecting arm 40, and a tail end of the extending arm 46 is located in front of the bent section 41. In another embodiment (not shown), the guide chamfer 42 may also be separated from the bent section 41, that is, the guide chamfer 42 is formed through extending from the extending arm 46 toward the side where the electronic card 5 is located, as long as the guide chamfer 42 extends toward the electronic card 5 and is located right below the edge of the electronic card 5.

Referring to FIG. 2 to FIG. 4, a process of inserting the electronic card 5 in a normal state is described as follows. As shown in FIG. 2 and FIG. 3, the electronic card 5 is obliquely inserted into the slot 10 with the connecting finger at the front end in alignment with the slot 10 and the rear end thereof higher than the front end. A downward pressure is then applied on the rear end of the electronic card 5, so as to rotate and press downward the rear end with the front end as an axis of rotation. When the rear end is pressed downward, as the edge of the electronic card 5 is away from the transition plane 43, the edge directly contacts the guide chamfer 42 and applies a downward acting force and a lateral acting force thereon. The guide chamfer 42 is pressed downward and expands outward under the two acting forces. Meanwhile, the connecting arm 40 and the bent section 41 undergo an elastic deformation along a bending direction, and the edge of the electronic card 5 slides downward along the guide chamfer 42 and moves to the normal working position shown in FIG. 4. At this time, the connecting arm 40 and the bent section 41 release elastic potential energy, and the guide chamfer 42 restores to its original position under an elastic restoring force, that is, the guide chamfer 42 rebounds upward and inward to a position above the electronic card 5, so as to press the electronic card 5. The stopping portion 44 enters the notch 50 at this time, so as to prevent the electronic card 5 exiting from a rear side.

During card withdrawal, the pulling portion 45 may be pulled outward, so that the pulling portion 45 moves toward the outside, that is, away from the electronic card 5. At this time, the pulling portion 45 drives the guide chamfer 42 and the stopping portion 44 to move toward the outside. When the stopping portion 44 exits from the notch 50 and the guide chamfer 42 shifts from the edge of the electronic card 5, as stopping in front and back as well as up and down directions disappears, the rear end of the electronic card 5 automatically bounces upward until the rear end is higher than the front end. At this time, the electronic card 5 can be directly pulled out from the slot 10.

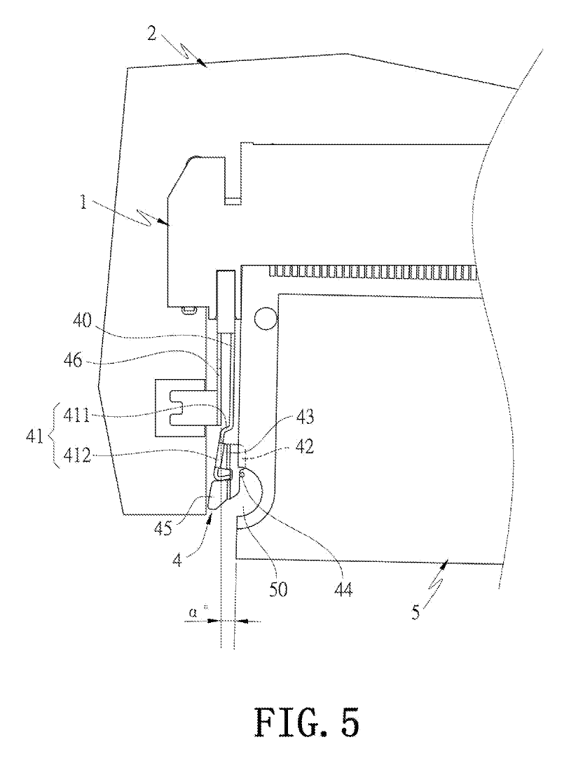

As shown in FIG. 5, when the electronic card 5 is inserted in an abnormal state, the connecting finger at the front end of the electronic card 5 is not in alignment with the slot 10, and an angle of α° (α is not equal to 0) is formed between a straight line where the side edge of the electronic card 5 is located and a straight line where the extending arm 46 is located. The rear end of the electronic card 5 shifts from the normal position significantly. If the user forcibly applies a downward pressure on the rear end of the electronic card 5, so as to rotate and press downward the rear end with the front end as an axis of rotation, as the bent section 41 is bent outward away from the edge of the electronic card 5, the edge of the electronic card 5 still does not press the top surface of the bent section 41, but instead, contacts the guide chamfer 42. When the user presses the electronic card 5 downward, the guide chamfer 42 can still expand outward as during normal card insertion, and a situation that the latch 4 is easily damaged due to an excessive force applied by the user is avoided, thereby being favorable for repeated card insertions.

The present invention, among other things, has the following beneficial effects.

1. As the connecting arm 40 extends backward and is bent to form the bent section 41 away from the electronic card 5, a certain distance is maintained between the top surface of the bent section 41 and the edge of the electronic card 5 (at the normal working position). In this way, it can be effectively ensured that the edge of the electronic card 5 does not press the transition plane 43, or press the top surface of the bent section 41 downward, but instead, contacts the guide chamfer 42 and applies a lateral acting force thereon, so that the guide chamfer 42 expands outward to leave a space for the electronic card 5. Therefore, the electronic card 5 can be smoothly pressed downward to the normal working position.

2. As the connecting arm 40 extends backward and is bent to form the bent section 41 away from the electronic card 5, a certain distance is maintained between the top surface of the bent section 41 and the edge of the electronic card 5 (at the normal working position). When the front end of the electronic card 5 does not completely enter the slot 10, making the connecting finger part askew to some extent, even if the rear end of the electronic card 5 substantially aligned with the bent section 41 shifts from the normal position laterally, the edge of the electronic card 5 does not press the transition plane 43 or press the top surface of the bent section 41 downward, but instead, contacts the guide chamfer 42 and applies a lateral acting force thereon, so that the guide chamfer 42 expands outward to leave a space for the electronic card 5, therefore preventing the latch 4 from being damaged due to an excessive downward pressure, effectively ensuring the function of the latch 4 for buckling the electronic card 5, and saving the cost.

3. As a side of the connecting arm 40 is disposed with the extending arm 46 parallel to the connecting arm 40, when the edge of the electronic card 5 pushes the bent section 41 and drives the connecting arm 40 to expand outward, the extending arm 46 can stop the connecting arm 40, therefore preventing the connecting arm 40 from fatigue due to excessive deformation.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A card edge connector, for receiving an electronic card to be inserted therein, comprising:
(a) an insulating body, with a slot formed therein for receiving the electronic card therein;
(b) multiple conductive terminals, accommodated in the insulating body, wherein each of the conductive terminals at least partially enters the slot and contacts the electronic card therein; and
(c) at least one latch, comprising:
a connecting arm, wherein an end of the connecting arm is disposed in the insulating body and is located at a side of the slot;
a bent section, extending backward from the other end of the connecting arm and bent toward a side away from the electronic card; and
a guide chamfer, disposed at a side of the bent section close to the electronic card and inclined downward.

2. The card edge connector according to claim 1, wherein the bent section comprises a bent segment bent from a tail end of the connecting arm toward a side away from the electronic card, and a straight segment extending backward from a tail end of the bent segment and parallel to the connecting arm.

3. The card edge connector according to claim 1, wherein the guide chamfer extends integrally from the bent section.

4. The card edge connector according to claim 1, wherein the bent section and the guide chamfer are connected through a transition plane.

5. The card edge connector according to claim 1, wherein a pulling portion is disposed at a rear end of the bent section, and the pulling portion is formed through gradual widening of the guide chamfer from front to back.

6. The card edge connector according to claim 1, wherein the latch further comprises an extending arm located at a side of the connecting arm and away from the side where the electronic card is located.

7. The card edge connector according to claim 1, wherein a notch is formed at a side edge of the electronic card, a stopping portion is disposed on the latch, and the stopping portion extends toward the side where the electronic card is located and enters the notch, so as to prevent the electronic card from moving forward and backward.

8. The card edge connector according to claim 7, wherein the stopping portion is formed through extending from the bent section.

9. The card edge connector according to claim 7, wherein the bent section is located in front of the stopping portion.

10. The card edge connector according to claim 1, wherein the card edge connector is of a sinking type.

11. A card edge connector, for receiving an electronic card to be inserted therein, comprising:
(a) an insulating body, with a slot formed therein for receiving the electronic card therein;
(b) multiple conductive terminals, accommodated in the insulating body, wherein each of the conductive terminals at least partially enters the slot and contacts the electronic card therein; and
(c) at least one latch, comprising:
a connecting arm, wherein an end of the connecting arm is disposed in the insulating body and is located at a side of the slot;
a bent section, extending backward from the other end of the connecting arm and bent toward a side away from the electronic card;
an extending arm, located at a side of the connecting arm and away from the side where the electronic card is located; and
a guide chamfer, formed through extending from the extending arm, disposed at a side of the extending arm close to the electronic card and inclined downward.

12. The card edge connector according to claim 11, wherein the bent section comprises a bent segment bent from a tail end of the connecting arm toward a side away from the electronic card, and a straight segment extending backward from a tail end of the bent segment and parallel to the connecting arm.

13. The card edge connector according to claim 11, wherein a pulling portion is formed through gradual widening of the guide chamfer from front to back.

14. The card edge connector according to claim 11, wherein a notch is formed at a side edge of the electronic card, a stopping portion is disposed on the latch, and the stopping portion extends toward the side where the electronic card is located and enters the notch, so as to prevent the electronic card from moving forward and backward.

15. The card edge connector according to claim 14, wherein the stopping portion is formed through extending from the bent section.

16. The card edge connector according to claim 14, wherein the bent section is located in front of the stopping portion.

17. The card edge connector according to claim 11, wherein the card edge connector is of a sinking type.
